(19) United States
(12) Patent Application Publication
(10) Pub. No.: US 2020/0043020 A1
(43) Pub. Date: Feb. 6, 2020

(54) TERMINAL FOR COLLECTING A USER'S SATISFACTION FEEDBACK, COLLECTION SYSTEM COMPRISING THE TERMINAL, AND METHOD FOR COLLECTING A USER'S SATISFACTION FEEDBACK USING THE TERMINAL

(71) Applicant: YUMI TECHNOLOGY, Vaulx-en-Velin (FR)

(72) Inventor: Georges OBANOS, Vaulx-en-Velin (FR)

(21) Appl. No.: 16/486,418

(22) PCT Filed: Feb. 16, 2018
(86) PCT No.: PCT/EP2018/053944

§ 371 Date: Aug. 15, 2019

(30) Foreign Application Priority Data
Feb. 17, 2017 (FR) 1751300

(51) Int. Cl. G06Q 30/02; G09B 21/00; G06F 3/0488; H04H 60/33

(52) U.S. Cl. CPC G06Q 30/0201; G09B 21/007; H04H 60/33; G06F 3/04883; G06F 3/04886

(57) ABSTRACT

The terminal for collecting user satisfaction feedback comprises: a user interface including a loudspeaker and a video screen and adapted to present a message to a user according to one or more modes of communication; two buttons for collecting a user's feedback; an electronic processor programmed to implement the following steps: selecting, by means of a selection module, a communication mode for presenting the message from among a plurality of communication modes enabled by the user interface; sending a message according to the communication mode selected; and collecting feedback submitted by the user.

The present invention relates to a terminal for collecting a user's satisfaction feedback, a collection system comprising the terminal and a method of collecting a user satisfaction feedback by means of that terminal.

There are known electronic terminals used to collect the feedback of users on a service rendered. These terminals are intended to be placed in a fixed location in a public place, such as a shopping center, an airport hall, a waiting room or public toilets. Such terminals have a simplified and intuitive user interface, allowing a user to quickly submit a feedback when passing in front of the terminal. This interface generally includes at least one button to express a positive feedback and a button to express a negative feedback as well as printed visual indications indicating which feedback is associated with each button. The feedbacks collected are recorded for later use, for example to establish satisfaction statistics.

Application WO-2011/048273 describes an example of such a terminal.

These known terminals have the disadvantage that they are not usable by people with disabilities, or by illiterate people and/or those suffering from cognitive disorders. For example, a blind or visually impaired person may not distinguish the different buttons and their respective meanings and, in fact, is not able to answer correctly the question posed by the terminal. Thus, the simplicity of the interface makes the terminal unusable for many categories of users.

It is these drawbacks that the invention intends to remedy more particularly by proposing a collection terminal and a method of collecting a user satisfaction feedback, by means of an inclusive user interface accessible to all users.

For this purpose, the invention relates to a terminal for collecting a user's satisfaction feedback, said terminal comprising:

A user interface, including a loudspeaker and a video screen embedded on a main face of a terminal housing, the user interface being adapted to present a message to a user according to one or more modes of communication; at least two actionable buttons located on the main face of the housing, each button being configured to emit a response signal when it is actuated by the user to collect a user's feedback;

an electronic processor, programmed to implement the steps of:

acquiring a questionnaire comprising a message to be presented to a user, this questionnaire being acquired from a remote computer server;

selecting, by means of a selection module, a communication mode for presenting the message among a plurality of communication modes enabled by the user interface;

sending a message to a user and through the user interface, according to the selected communication mode;

collecting a feedback issued by the user, this acquisition comprising the acquisition of a response signal emitted by one of the actionable buttons in response to its actuation by the user.

Thanks to the invention, the terminal comprises a user interface that is universal and allows communication according to several complementary communication modes. For example, a question may be asked to the user in a visual and/or auditory mode. Thus, the communication embodiments between the user and the terminal are adaptable according to the capacities of the user.

According to the advantageous but non-obligatory aspects of the invention, such a method may incorporate one or more of the following characteristics, taken alone or in any technically permissible combination:

The terminal further comprises an authentication module adapted to identify a user and the electronic processor is programmed to select the communication mode of the user interface according to the user identified by means of the authentication module.

Each button is further identified by a marking area.

The marking areas include a Braille code and include for this purpose one or more rigid pads projecting from the surface of the marking area.

The electronic processor comprises a voice synthesis module, adapted to generate, from a predefined setpoint, a voice message to be transmitted by the loudspeaker.

The voice synthesis module of the electronic processor is configured to change the sound volume, and/or the sound frequency and/or the prosody of the generated voice message, based on information provided by the selection module.

According to another aspect, the invention relates to a system for collecting a user satisfaction feedback, this system comprising a computer server and a feedback collection terminal, the computer server and the collection terminal being connected by a data link. The computer server includes a module for generating a questionnaire and the collection terminal is as described above.

According to another aspect, the invention relates to a method for collecting a user's satisfaction feedback by means of a terminal, this terminal comprising:

A user interface, including a loudspeaker and a video screen embedded on a main face of a terminal housing, the user interface being adapted to present a message to a user according to one or more modes of communication;

at least two actionable buttons located on the main face of the housing, each button being configured to emit a response signal when it is actuated by the user to collect a user's feedback;

an electronic processor;

This method being characterized in that it comprises the steps of:

Acquiring, by the electronic processor of the terminal, a questionnaire comprising a message to be presented to a user, the questionnaire being acquired from a remote computer server;

selecting, by means of a module for selecting the electronic processor of the terminal, a communication mode for presenting the message among a plurality of modes of communication enabled by the user interface;

sending a message to a user and through the user interface, according to the selected communication mode;

collecting a feedback issued by the user, this acquisition comprising the acquisition by the electronic processor of a response signal emitted by one of the actionable buttons in response to its actuation by the user.

According to the advantageous but non-obligatory aspects of the invention, such a method may incorporate one or more of the following characteristics, taken alone or in any technically permissible combination:

The step of selecting the communication mode comprises the automatic identification of the user by an authentication module of the terminal, the selection of the communication mode being carried out by the selection module according to the result of the identification of the user;

The modes of communication of the user interface comprise a graphic communication mode and an audio communication mode.

The invention will be better understood and other advantages thereof will appear more clearly in the light of the following specification, an embodiment of a terminal, a system and a user's feedback collection method, given solely by way of example and with reference to the accompanying drawings, in which:

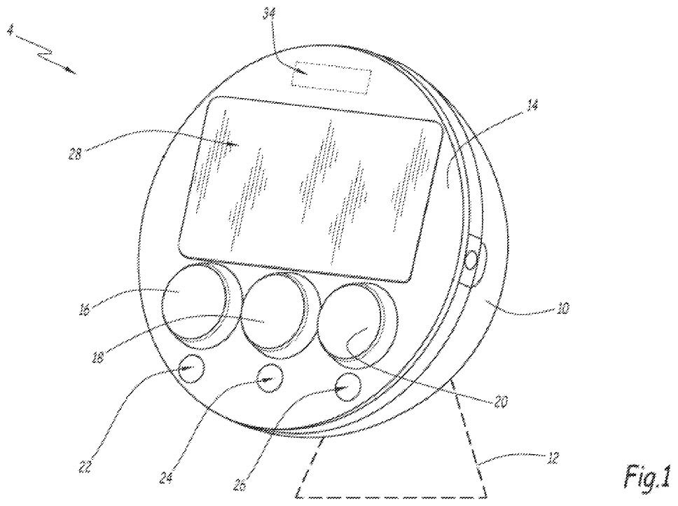

FIG. 1 is a schematic representation, in a simplified perspective view, of a user's feedback collection terminal, according to a first embodiment of the invention;

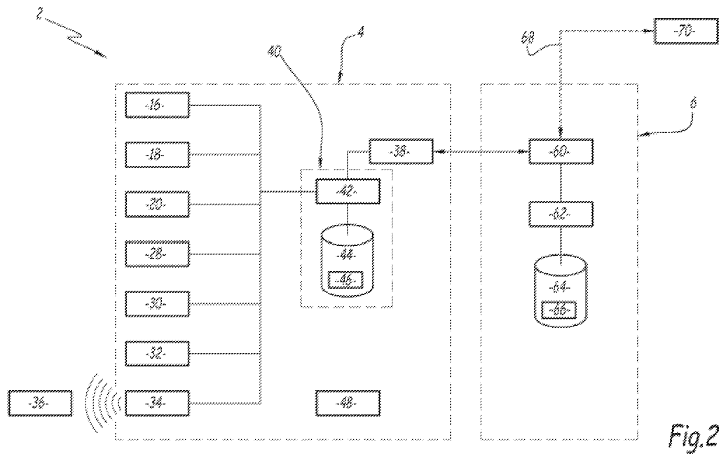

FIG. 2 is a simplified block diagram of the operation of a system for collecting a user's feedback, this system comprising the terminal of FIG. 1;

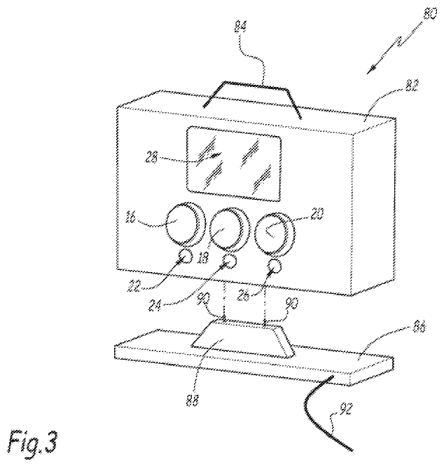

FIG. 3 is a schematic representation, in a simplified perspective view, of a terminal for collecting a user's feedback, according to a second embodiment of the invention;

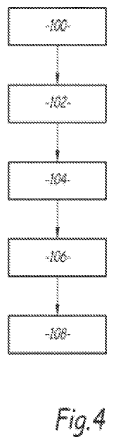

FIG. 4 is a flow diagram of an operating method of the collection terminal of FIG. 1 for collecting a user's feedback in accordance with the invention.

FIGS. 1 and 2 show a system 2 comprising a terminal 4, to collect a user's feedback in a public reception area, and a remote computer server 6.

As illustrated in FIG. 1, the terminal 4 comprises a housing 10 mounted on a support 12. To simplify FIG. 1, this support is not illustrated in detail and appears in dotted lines. The support 12 makes it possible to fix the terminal 4 so that it is placed at a height greater than or equal to 1 meter.

The housing 10 has a main face 14 on which a man-machine communication interface, also called the user interface, is shown.

The purpose of the user interface is to present to a user a message expressing a question asked to which he wishes to answer, this answer forming a satisfaction feedback that one wishes to collect. The question may relate to a satisfaction feedback on a specific service from which he has benefited, for example what he thinks of the quality of a meal he has just consumed. However, other applications are possible.

In this illustrative example, the main face 14 has a planar and circular shape and delimits a front face of the housing 10. The rear of the housing 10 has a rounded half-shell shape extending away from the main face 14. Preferably, the housing 10 is made of a rigid material, such as a molded thermoplastic material.

The terminal 4 comprises at least two actionable buttons located on the main face 14. These buttons are intended to collect a user's satisfaction feedback.

Each button here is of the pushbutton type and comprises for this purpose a movable portion, reversibly movable in translation relative to a fixed base, between a depressed position and a relaxed position. For example, the moving part of the button has a flat outer face. The button also comprises elastic return means which bring the moving part back to the relaxed position.

In this example, the buttons are three in number and bear the references 16, 18 and 20. The buttons 16, 18 and 20 are here identical.

Advantageously, the buttons 16, 18 and 20 may be backlit, for example when actuated by the user.

Each button 16, 18 and 20 is adapted to deliver a response signal, for example an electrical signal, which is representative of its operating state. Here, this response signal takes a different value depending on whether the button is in the depressed position or in the released position.

The main face 14 also comprises marking zones 22, 24 and 26, each associated with one of the buttons 16, 18 and 20. Each marking zone 22, 24 and 26 is intended to receive a visual indicator, not shown in FIG. 1, indicating the meaning of the associated button.

For example, the visual indicator is a “smiley” pictogram that indicates a degree of satisfaction: positive, neutral or negative.

In this example, the marking areas 22, 24 and 26 are formed directly on the main face 14, below the buttons 16, 18 and 20 to which they are respectively associated. Alternatively, the marking areas 22, 24 and 26 may each be formed directly on the support surface of the button with which it is associated.

Advantageously, the marking zones 22, 24 and 26 comprise an inscription in Braille code, not shown. They include for this purpose one or more rigid pads projecting from the surface of the marking area. This inscription in Braille code is arranged to indicate the meaning of the associated button, for example to indicate the degree of satisfaction.

The inscription in Braille code may be placed on the marking zones 22, 24 and 26, either in place of the visual indicator or in addition to the visual indicator.

According to another variant, the inscription in Braille code is provided on additional marking areas, placed on the respective support faces of the buttons 16, 18, 20, and being distinct from the marking zones 22, 24, 26, those being preferentially placed under the buttons 16, 18, 20 on the main face 14. The Braille code entries may also be provided both on the marking areas 22, 24, 26 and on the additional marking areas.

Alternatively, the number of buttons may be different. For example, the button 18 is omitted. The corresponding marking area 24 is then omitted accordingly.

The user interface also includes a video screen 28, adapted to display visual information to the user. The screen 28 is recessed on the main face 14. For example, an opening is cut in the main face 14 to receive this screen 28. Optionally, the screen 28 is a touch screen.

The user interface also contains a loudspeaker 30 and a microphone 32, housed inside the housing 10. For example, the housing has orifices, not shown, arranged in front of the loudspeaker 30 and in front of the microphone 32 to facilitate the passage of a sound signal.

Optionally, the terminal 4 also comprises an inductive auditory loop, or “T loop”, adapted to be used jointly or in place of the loudspeaker 30 to transmit an auditory message to the user when it is a hearing-impaired person equipped with a compatible hearing aid.

Advantageously, the terminal 4 is also provided with an authentication module 34 for acquiring information on a user. The authentication module 34 is intended to work together with identification data, for example carried by a user.

For example, the authentication module 34 comprises a radio transponder, preferably NFC type for “Near Field Communication” and/or RFID type for “Radio Frequency Identification Device”. The identification data are then contained in an identification card 36 carried by the user, for example containing a radio element readable by the radio transponder.

Alternatively, the authentication module 34 comprises an optical camera, associated with data processing means programmed to recognize an optical marker, such as a bar code or a QR code type code. The identification data is then encoded by this optical marker.

According to another variant, the module 34 is programmed to perform a user recognition on biometric criteria and includes, in particular, biometric sensors, such as a fingerprint reader. In this case, the user does not need to wear an identification card. As illustrated in FIG. 2, the terminal 4 also comprises a telecommunication module 38 and an electronic processor 40.

The telecommunication module 38 makes it possible to put the terminal 4 in communication with the remote server 6, for example through a telecommunications network such as the internet network or a mobile telephone network.

For example, the telecommunication module 38 comprises a wireless WiFi type communication interface or GSM or LTE type. Alternatively, the module 38 has an Ethernet interface for establishing a wired communication.

The processor 40 comprises a logic computing unit 42 and an information recording means 44 connected to each other by means of an internal data bus. The computing unit 42 here is a microprocessor. The means 44 includes a computer memory, such as a flash memory module or a magnetic hard disk. The means 44 contain executable instructions 46 intended to ensure the operation of the terminal 4 when they are executed by the calculation unit 42.

The processor 40 is also connected to the buttons 16, 18, 20 to acquire the response signals resulting from the activation of the buttons 16, 18, 20. These signals are for example different for each button, and each of them is associated with a particular value of satisfaction feedback.

As an illustrative example, the button 16 is here associated with a positive feedback, the button 18 is associated with a neutral feedback, and the button 20 is associated with a negative feedback.

The processor 40 is also connected to the user interface including the screen 28, the loudspeaker 30 and the microphone 32, the authentication module 34 and the telecommunications module 38 via dedicated data links.

As an illustrative example, the computer 40 is here a “Raspberry Pi®” type mini-computer.

The terminal 4 also includes a power supply module 48 for electrically powering the terminal 4, either from an external source or autonomously.

For example, the terminal 4 is intended to be fixedly placed in a public place and can therefore advantageously be connected to a power supply network by means of a cable for supplying the power supply module 48.

Optionally, the power supply module 48 comprises energy storage means, such as a rechargeable storage battery or a supercapacitor.

The processor 40 is programmed to operate the terminal 4. In particular, the processor 40 is adapted to control the display of information on the screen 28, by means of a graphics controller, in particular to display questions to the user. These questions can be displayed as a text, but also in the form of images by means of pictograms. The font size of the text can be changed.

In addition, the screen 28 here is a touchscreen, it allows data entry, using a graphical interface. This data entry may be authorized only for maintenance operations by an authorized operator, authenticated by means of a chip 36 provided for this purpose and the authentication module 34.

The computer 40 is also adapted to control the loudspeaker 30 to control the transmission of a sound signal to the user, for example to ask the question in the form of a voice message.

This voice message may be previously recorded in the means 44.

As a variant, the voice message is generated by a speech synthesis module, implemented in software form by the processor 40.

This speech synthesis module makes it possible to create a voice message from instructions provided for this purpose and allows the adaptation of characteristics of the voice message sent. For example, the speech synthesis module can generate the voice message with a specific prosody.

Advantageously, the processor 40 also comprises a module for selecting the communication mode of the user interface. This selection module is here implemented in software, by means of instructions 46.

The selection module makes it possible to select a communication mode of the user interface for presenting the question to the user from among a plurality of communication modes enabled by the user interface, for example a video mode or an audio mode. This selection can be manual or automatic.

In the case of a manual selection, the selection module is intended to receive a choice of a communication mode made by an authorized operator, for example by means of the touch screen 28 and after having authenticated the help from the module 34. The terminal 4 later presents the question to the user according to the selected communication mode. This selection can be maintained for several different users.

In the case of an automatic selection, the selection is carried out automatically, on a case by case basis according to the user. For example, the user carries a chip containing an identifier 36 associated with a preferential mode of communication. Then, this mode of communication is automatically selected by the terminal 4 when the user wishes to make use of the terminal 4 to give a feedback of satisfaction.

The identifier 36 of the user is preferably associated with a preferential mode of communication, taking into account a disability of the user, to select a communication mode adapted to the disability of the user so that the message displayed by the terminal 4 can be understood by the user.

This identification is, for example, carried out by means of a predefined identification database stored by the processor 40 or by the remote server 6. For example, for each identifier, a preferential communication mode is associated with this identifier in the database.

In this example, the communication mode can be voice or graphic.

In the graphic communication mode, the message is presented in the form of text, and/or in the form of one or more images, and/or in the form of video. The size of the text displayed on the screen 28 can advantageously be adapted according to a possible visual impairment of the user. In addition, the images may include pictograms specifically selected from an image database adapted for people with cognitive impairment. These pictograms are advantageously chosen when the user is illiterate or has trouble understanding.

In the voice or audio communication mode, the message is transmitted in sound form, playing a predetermined sound, or synthesizing an audible message by means of the speech synthesis module. The emission is controlled by the computer 40 by means of the loudspeaker and/or the auditory loop.

The server 6 allows the programming of questionnaires as well as the collection of the answers recorded by the terminal 4.

The server 6 here comprises communication means 60, adapted to allow the establishment of a remote telecommunications link with the communications module 38 of the terminal 4. For example, the communication between the terminal 4 and the server 6 is performed via the Internet network.

The server 6 also comprises an electronic processor 62 and a database 64 which stores in particular a set of executable instructions 66.

The server 6 can in particular be accessed through a communications link 68 by a remote operator provided with a connection terminal 70. The terminal 70 is for example a mobile phone or a tablet or a microcomputer. The processor 62 here implements a questionnaire generation module, allowing an operator to program questionnaires intended to be broadcasted on the terminal 4.

The server 6 can supervise several similar terminals 4 arranged at different points of the same geographical site or arranged in different geographical sites of the same group of establishments.

FIG. 3 represents a collection terminal 80 according to a second embodiment of the invention and which performs similar functions to the terminal 4. The elements of the collection terminal 80 which are similar to those of the terminal 4 have the same references and are not described in detail, insofar as the description above can be transposed to them.

The terminal 80 differs in particular from the terminal 4 in that it is portable and is intended to be easily moved to be installed closer to the users. This terminal 80 is advantageously usable when it is necessary to collect a feedback from a person in a specific context, for example when a practitioner is led to visit a user and must collect a feedback from this user.

For this purpose, the terminal 80 has a housing 82 in the form of a bag provided with a gripping element 84 such as a handle. The main face of this housing 82 corresponds to one of the lateral faces of the bag.

Optionally, the housing 82 is provided with a movable flap, not shown, which is adapted to cover and protect the main face during the transport of the terminal 80. This flap is for example formed by the lid of the bag.

The terminal 80 also comprises a support 86 detachable from the housing 82.

The support 86 advantageously comprises a power supply plug 88 provided with connectors 90 intended to be electrically powered from an external power supply source via a power cable 92. For this purpose, the housing 82 has a housing of complementary shape to the plug 88 as well as connectors of complementary shape to the connectors 90 and is connected to the power supply module 48.

When the housing 82 is placed on the support 86, the receptacle 88 is received in the corresponding housing of the housing 82 and the connectors 90 make it possible to convey an electric supply current to the supply module 48, for example to recharge a battery module 48.

An example of operation of the terminal 4 to collect a user's feedback is now described with reference to FIG. 4. This example is also applicable to the operation of the terminal 80. Beforehand, a questionnaire, or survey, is generated by means of the server 6, for example at the request of an operator from the terminal 70. For example, a data set is generated by the server 6, this set of data containing the question to ask. Optionally, these data contain the question to be recorded in several forms so as to be broadcasted according to different communication means of the user interface of the terminal 4. For example, the questionnaire data contains the pictograms to be displayed on the screen 28 and/or the text corresponding to the question and/or a sound recording to be broadcasted or instructions to synthesize a voice message.

During a step 100, a predefined survey is acquired by the terminal 4. This survey is for example previously created by an operator using the server 6 and is sent from the server 6 to the terminal 4, by means of the data link established between the telecommunication modules 38 and 60.

Then, the terminal 4 is activated to display the question.

Advantageously, during a step 102, the processor 40 selects, thanks to the selection module, a preferential mode of communication of the user interface. This allows in particular to adapt the communication terminal 4 to the user depending on the disability of the user. As previously explained, this selection can be done automatically or manually, for a set of users or on a case-by-case basis for each user.

In response, during a step 104, the terminal 4 sends a message containing the question to the user, presenting the question on the user interface.

This presentation can be performed either according to all the communication modes of the user interface, or according to one or more modes of communication.

For example, if the sound communication mode is used, then the question is presented by sound. The processor 40 triggers the transmission of an appropriate sound message by means of the loudspeaker 30. The sound message is either pre-recorded or synthesized according to instructions previously received for this purpose.

During a step 106, the terminal 4 acquires a feedback from the user, by means of the buttons 16, 18 and 20. For example, the user actuates the button corresponding to the feedback he wishes to give, for example actuates the button 16 to give a positive feedback. In doing so, the corresponding response signal resulting from the actuation of the button 16 is acquired by the processor 40. In response, the latter records the corresponding feedback, for example by incrementing a positive feedback counter contained in the recording means 44. Finally, during a step 108, the processor 40 transmits the collected response to the server 6. For example, the collected responses are transmitted to the server 6 with a predetermined periodicity, or when the number of feedbacks collected exceeds a predefined threshold.

This transmission is carried out here via the communication link established between the telecommunication modules 38 and 60.

According to implementation variants, the acquisition of the response of the user during step 106 is followed by the acquisition of a complementary response, preferably a voice or sound response acquired by the microphone 32. Thus, once the answer is acquired by means of one of the buttons 16, 18 and 20, the user is invited to complete his answer, for example to give a qualitative comment or justification to his choice. For example, this invitation is displayed on the screen 28 in a graphic form, such as a text or a pictogram, or audibly by means of the loudspeaker 30. The invitation may be in particular displayed on the screen 28 in the form of a predefined pictogram that the user is invited to press to trigger the acquisition of sounds by the microphone 32. The user gives his complementary answer by speaking in the microphone 32.

Then, the complementary response thus acquired by the microphone 32 is recorded by the processor 40 in order to exploit the additional response given by the user. For example, the processor 40 automatically transmits this complementary response to the server 6, where it is then recorded.

According to examples, the server 6 is provided with an automatic voice recognition module, preferably in software form, which automatically generates a text corresponding to the words contained in this recording. This text is stored as an example in the database 64. In a variant, the voice recognition is implemented by the processor 40. The text extracted from the supplementary message by the processor 40 is then sent to the server 6.

Thanks to the invention, the user interface makes it possible to communicate according to several complementary communication modes. In particular, it makes it possible to communicate to users suffering from a disability that prevents them from perceiving the message displayed by the known terminals. In other words, it increases the chances that the message sent to the user is understood even if this user has a disability or communication disorders.

The possibility of communicating with the user according to several distinct and complementary modes gives it more chances to understand the user, especially when the person has a disability or handicap that prevents him from perceiving or understanding a message issued according to a specific communication mode. Thus, the communication embodiments between the user and the terminal are adaptable according to the capacities of the user and allows it to take his disability into account.

The embodiments and alternatives provided above may be combined with one another to generate new embodiments.

1. A terminal for collecting a user satisfaction feedback, the terminal being characterized in that it comprises:
a user interface, including a loudspeaker and a video screen embedded in a main face of a terminal housing, the user interface being adapted to present a message to a user according to one or more communication modes;
at least two actionable buttons located on the main face of the housing, each button being configured to emit a response signal when, it is actuated by the user to collect a feedback from the user; and
an electronic processor, programmed to implement steps of:
acquiring a questionnaire comprising a message to be presented to a user, the questionnaire being acquired from a remote computer server;
selecting, by means of a selection module, a communication mode for presenting the message among a plurality of communication modes enabled by the user interface;
sending a message to a user and using the user interface, according to the selected communication mode; and
collecting a feedback issued by the user, the acquisition comprising the acquisition of a response signal emitted by one of the actionable buttons in response to its actuation by the user.

2. The terminal according to claim 1, characterized in that it further comprises an authentication module adapted to identify a user and in that the electronic processor is programmed to select the communication mode of the user interface according to the user identified by means of the authentication module.

3. The terminal according to claim 1, characterized in that each button is further identified by a marking area.

4. The terminal according to claim 3, characterized in that the marking areas comprise a Braille code and include for this purpose one or more rigid pads projecting from the surface of the marking area.

5. The terminal according to claim 1, characterized in that the electronic processor comprises a voice synthesis module, adapted to generate, from a predefined setpoint, a voice message to be issued from the loudspeaker.

6. The terminal according to claim 5, characterized in that the voice synthesis module of the electronic processor is configured to change the sound volume, or the sound frequency or the prosody of the voice message generated, depending on the information provided by the selection module.

7. A system for collecting a user satisfaction feedback, characterized in that said system comprises a computer server and a terminal, for collecting a feedback, the computer server and the collection terminal being connected by a data link, wherein the computer server comprises a module for generating a questionnaire and wherein the collection terminal is according to claim 1.

8. A method for collecting a user satisfaction feedback by means of a terminal, said terminal comprising:
a user interface, including a loudspeaker and a video screen embedded on a main face of a terminal housing, the user interface being adapted to present a message to a user according to one or more modes of communication;
at least two actionable buttons located on the main face of the housing, each button being configured to emit a response signal when it is actuated by the user to collect a warning of the user; and
an electronic processor;
the method being characterized in that it comprises the steps of:
acquiring, by the electronic processor of the terminal, a questionnaire comprising a message to be presented to a user, the questionnaire being acquired from a remote computer server;
selecting, by means of a module for selecting the electronic processor of the terminal, a communication mode for presenting the message among a plurality of communication modes enabled by the user interface;
sending a message to a user and using the user interface, according to the selected communication mode; and
collecting a feedback issued by the user, the acquisition comprising the acquisition by the electronic processor of a response signal emitted by one of the actionable buttons in response to its actuation by the user.

9. The method according to claim 8, characterized in that the step of selecting (402)-the communication mode comprises the automatic identification of the user by an authentication module of the terminal, the selection of the communication mode being performed by the selection module according to the results of the identification of the user.

10. The method according to claim 8, characterized in that the communication modes of the user interface comprise a graphic communication mode and an audio communication mode.

11. The method according to claim 9, characterized in that the communication modes of the user interface comprise a graphic communication mode and an audio communication mode.
